(19) United States
(12) Patent Application Publication
(10) Pub. No.: US 2002/0015268 A1
(43) Pub. Date: Feb. 7, 2002

(54) Spin valve head using high-coercivity hard bias layer

(76) Inventors: Sining Mao, Savage, MN (US); Zheng Gao, Bloomington, MN (US); Ananth Naman, Edina, MN (US); Dean Walter Markuson, Anoka, MN (US); Paul Edward Anderson, Eden Prairie, MN (US); Lujun Chen, Eden Prairie, MN (US); Song Xue, Eden Prairie, MN (US)

Correspondence Address: MERCHANT & GOULD PC, P.O. BOX 2903, MINNEAPOLIS, MN, 55402-0903, US

(21) Appl. No.: 09/815,746

(22) Filed: Mar. 23, 2001

Related U.S. Application Data
(60) Provisional application No. 60/191,821, filed on Mar. 24, 2000.

(51) Int. Cl. G11B 5/39

(52) U.S. Cl. 360/324.12

(57) ABSTRACT

A magnetic sensor and method for making the sensor are disclosed. The sensor includes a giant-magnetoresistive sensing layer having a ferromagnetic free layer and a hard bias layer to maintain the free layer in a single-domain state or to stabilize the free layer. The hard bias layer has a coercivity of at least 2,000 Oe and a magnetic remnance times thickness at least twice the value of the saturation magnetization times thickness of the free layer. The hard bias layer includes a permanent magnetic layer formed on top of a seed layer made of the alloy TiW or other similar alloys. The seed layer may also be a bi-layer having a layer of TiW or ther similar alloys and a layer of soft magnetic material, with the former in contact with the permanent magnetic layer.

### RELATED APPLICATIONS

This application claims priority to the provisional patent application Ser. No. 60/191,82 1, entitled “Magnetic Stability Improvement of Spin Valve Heads Using High Coercivity Hard Bias Layer”, filed on Mar. 24, 2000, which is hereby incorporated by reference.

### FIELD OF THE INVENTION

The present invention relates generally to magnetic read/write heads and more specifically to spin valve heads using high-coercivity hard bias layers.

### BACKGROUND OF THE INVENTION

Magnetoresistive (MR) sensors find wide application in high capacity magnetic disk drives because of the capability to read data from the surface of a disk at higher linear densities than thin film inductive heads. An MR sensor typically includes a layer of MR material, i.e., a material with a magnetic field-dependent resistivity.

One type of MR sensor is the giant magnetoresistive (GMR) sensor utilizing the GMR effect. As schematically shown in an air-bearing-surface (“ABS”) view in FIG. 1, a type of GMR sensor 100, known as “spin valves”, typically includes a ferromagnetic “free” layer 110 separated from a ferromagnetic “pinned” layer 120 by a non-magnetic, electrically-conducting spacer 115. The stack of layers may be fabricated on top of a substrate 128, with either the free layer 110 or pinned layer 120 being closer to the substrate 128 than the other. The magnetization of the pinned layer is fixed by a pinning layer 125, which is typically antiferromagnetic. The magnetization of the free layer 110 is free to rotate in response to the magnetic signals (or fields) from the recording medium. The resistance of the MR sensor 100 varies as a function of the spin-dependent transmission of the conduction electrons between the two ferromagnetic layers through the non-magnetic layer and the accompanying spin-dependent scattering that take place at the interface of the magnetic and non-magnetic layers and within the magnetic layers.

GMR sensors offer many advantages over other types of MR sensors, in large part because electrical conductivity in GMR sensors typically varies more widely for the same change in magnetic field.

It is typically desirable to stabilize, or maintain uniformity of magnetization, in the free layer of a GMR sensor. Preferably the free layer is maintained as a single magnetic domain. Non-uniform or multi-domain configuration results in reduced sensitivity and increased noise due to the partially offsetting magnetic moments between domains and noises such as those caused by the Barkhaussen effect. Permanent magnet hard bias films, such as the those 130 and 135 schematically illustrated in FIG. 1, have been used to provide the bias to maintain the single-domain state in the free layer 110. The magnetic biasing field provided by the bias film must be sufficiently high to achieve stabilization. Poor stabilization causes the magnetization (represented as vectors 210 if FIGS. 2(a) and 2(b)) to lose uniformity at the edges of the free layer, giving rise to hysterises, or non-linearity in the response of the sensor, as shown in FIG. 2(c), and thus noise. To maintain the single-domain configuration, the transition excitation, as measured by magnetic remnence times thickness (Mrt) for the permanent magnetic hard bias film must be significantly larger than saturation magnetization times thickness (Mst) of the free layer. The coercivity of the bias film must be sufficiently high (or the magnet sufficiently “rigid”) so that the magnetic field created by the recording medium does not destroy the magnetic configuration of the permanent magnetic film. It is typically desirable to achieve a coercivity of at least ten times the medium-generated field. For example, for a medium-generated field of 200 Oe, the hard bias film should have a coercivity of at least 2,000 Oe. The coercivity of the permanent magnetic material typically used in spin valve sensors decreases as temperature increases, as shown in FIG. 3, and the sensor typically operates at elevated temperatures (for example, between 100 and 200° C.). Thus, the coercivity of the hard bias film at room temperature should be sufficiently high so that the reduced coercivity at the elevated operating temperature still satisfies the requirement of at least ten times the medium generated field. It is typically desirable to obtain a stabilization coefficient (defined as the ratio between Mrt of the permanent magnet and Mst of the free layer) of at least 2 at operating temperature. Conventional materials, such as Cr-seeded CoCrPt and CoPt, used for spin valves cannot provide sufficient permanent magnetization without requiring a thick hard bias layer. Unfortunately, using thicker bias layers results in reduced coercivity of the layer as coercivity typically decreases as thickness increases (see FIG. 4, which shows a typical plot of the coercivity as a function of thickness). The reduced coercivity, in turn, results in destabilized edges near the free layer and thus an increased probability of formation of multiple domains. The traditionally used materials also lose a significant amount of coercivity as temperature increases and might produce an undesirably low coercivity at the normal operating temperatures of the sensor.

It is thus desirable to create a GMR sensor having a hard bias layer with improved performance parameters, such as reduced side reading and improved cross-track stability.

### SUMMARY OF THE INVENTION

Generally, based on the principles of this invention, the ferromagnetic free layer in a giant-magnetoresistive sensing layer used in a magnetic sensor is stabilized, or maintained in a signal-domain state, by a hard bias layer having a coercivity at least about ten times the magnetic field produced by the recording media.

According to one aspect of the invention, a magnetic sensor includes (a) a giant-magnetoresistive sensing layer comprising a ferromagnetic free layer; and (b) a hard bias layer having a coercivity of at least 2,000 Oe, at least 2,300 Oe or at least 2,500 Oe and positioned and configured to maintain the free layer in a single-domain state.

According to another aspect of the invention, the hard bias layer of the magnetic sensor includes (a) a seed layer that includes an alloy between Ti and W or another alloy between two elements chosen from the group W, Mo, Cr, V, Nb, Ta, Ti, Hf and Zr, where the two elements have different crystal structures; and (b) a permanent magnetic layer deposited on the seed layer, wherein the permanent magnetic layer includes an alloy comprising Co and Pt. The alloy of the seed layer may have a range of possible ratios between the two elements. For example, a TiW seed layer may include 1 to 15 atomic percent W.

According to another aspect of the invention, the permanent magnetic layer formed on the seed layer includes CoPt or CoPt doped with another element chosen from the group B, Cr, Ta, C, Zr, Rh and Re.

According to another aspect of the invention, the permanent magnetic layer formed on the seed layer is made of a material chosen from Co₃Pt, SmCo₅ and alloys FePt, FePd, FeNdB and MnAl.

According to another aspect of the invention, the seed layer is of a bi-layer structure including a alloy or compound layer described above for the seed layer and a layer of soft magnetic material such as Cr, Ta, CrZnNb and an Fe—Al—Si alloy, with the permanent magnetic layer in contact with the alloy or compound layer.

According to another aspect of the invention, a magnetic sensor includes (a) a giant-magnetoresistive sensing layer having a ferromagnetic free layer having a saturation magnetization; and (b) a hard bias layer positioned to maintain the free layer in a single-domain state, and having a magnetic remnance times thickness at least two times the value of the saturation magnetization times thickness of the free layer.

According to another aspect of the invention, a magnetic disk drive system includes (a) a surface of a magnetic media; (b) a magnetic sensor described above and positioned in proximity to the surface of the magnetic media; and (c) a driving mechanism configured to cause relative motion between the surface and the sensor.

According to another aspect of the present invention, a method of making a magnetic sensor includes (a) forming a giant-magneto-resistive sensing layer having a top surface, a bottom surface and at least a side surface intersecting the top and bottom surfaces; (b) depositing a seed layer abutting the sensing layer at the side surface, the seed layer including an alloy between two elements chosen from the group consisting essentially of W, Mo, Cr, V, Nb, Ta, Ti, Hf and Zr, wherein the two elements have different crystal structures; and (c) depositing, subsequent to step (b), a layer of permanent magnetic material on the seed layer.

The method of claim 19, wherein step (b) comprises providing a hard bias layer having a coercivity of at least 2,000 Oe.

### BRIEF DESCRIPTION OF THE DRAWINGS

Other objects and advantages of the invention will become apparent upon reading the following detailed description and upon reference to the drawings in which:

FIG. 1 shows the schematic ABS view of a conventional GMR sensor;

FIGS. 2(a) and (b) schematically show the distribution of magnetization in the free layer when the stabilization is insufficient;

FIG. 2(c) shows a plot of the response (measured as the 0-to-peak Low-Frequency Amplitude) of the sensor to magnetic signals. The response is non-linear. The point marked “point-11” corresponds to the magnetization distribution shown in FIG. 2(a); the point marked “point-31” corresponds to the magnetization distribution shown in FIG. 2(b);

FIG. 3 shows the coercivity of the a typical hard bias layer as a function of temperature;

FIG. 4 shows the coercivity of the a typical hard bias layer as a function of film thickness;

FIG. 5 shows the schematic ABS view of a GMR sensor based on the principles of the invention;

FIG. 6 shows a comparison between the hysteresis loops for the hard bias layer according to the invention and that for a prior art hard bias layer;

FIG. 7 shows a comparison between the remnant magnetization curves for the hard bias layer according to the invention and that for a prior art hard bias layer;

FIG. 8 shows the schematic top view of a disc drive system according to the invention; and

FIG. 9 shows a schematic, perspective view of a slider with a spin valve sensor according to the invention.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed, but on the contrary, the intention is to cover all modifications, equivalents, and alternatives falling within the spirit and scope of the invention as defined by the appended claims.

### DETAILED DESCRIPTION OF PREFERRED EMBODIMENTS OF THE INVENTION

Generally, the GMR sensor based on the principles of the invention has a free layer, the magnetic domain configuration of which is maintained by a permanent magnetic layer that has a high coercivity and an Mrt at least two times the Mst of the free layer. The permanent magnetic layer may have a coercivity of at least ten times the magnetic field generated by the media that the sensor detects signals from. These properties are achieved by the use of TiW, or an alloy between Ti and W, or similar materials (such as compounds and alloys between metals of groups IIIB, IVB and VIB in the periodic table) as seed layer material and depositing permanent magnetic material on the seed layer.

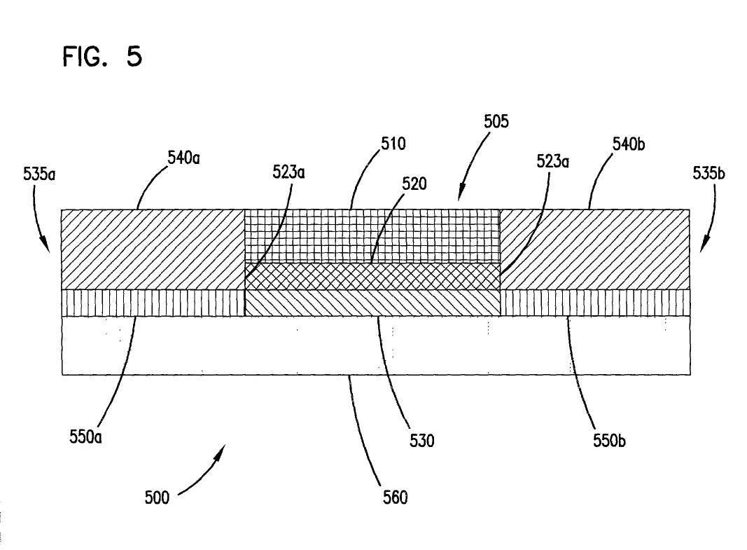

Referring to FIG. 5, which is a schematic ABS view, a GMR sensor 500 constructed based on the principle of the invention includes a stack 505 of sandwiched layers that sequentially include a GMR sensing layer 510, an separating layer 520 and a soft adjacent layer (SAL) 530.

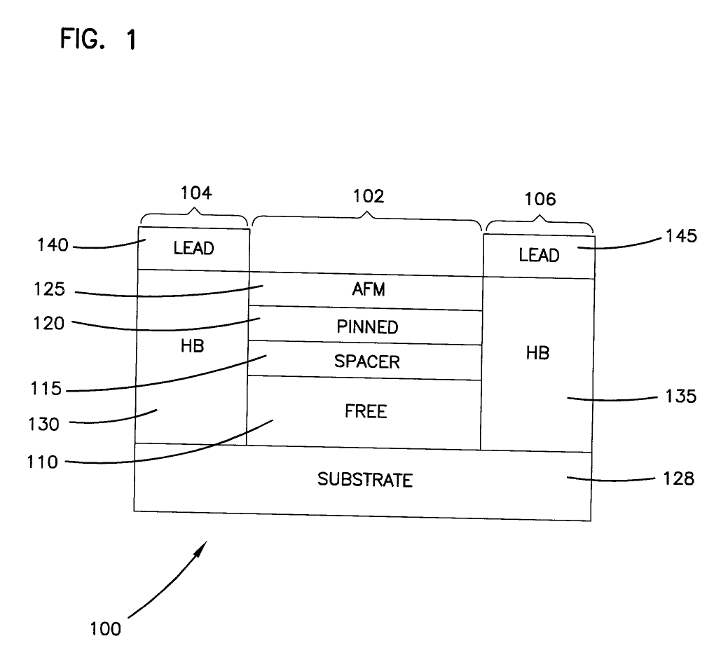

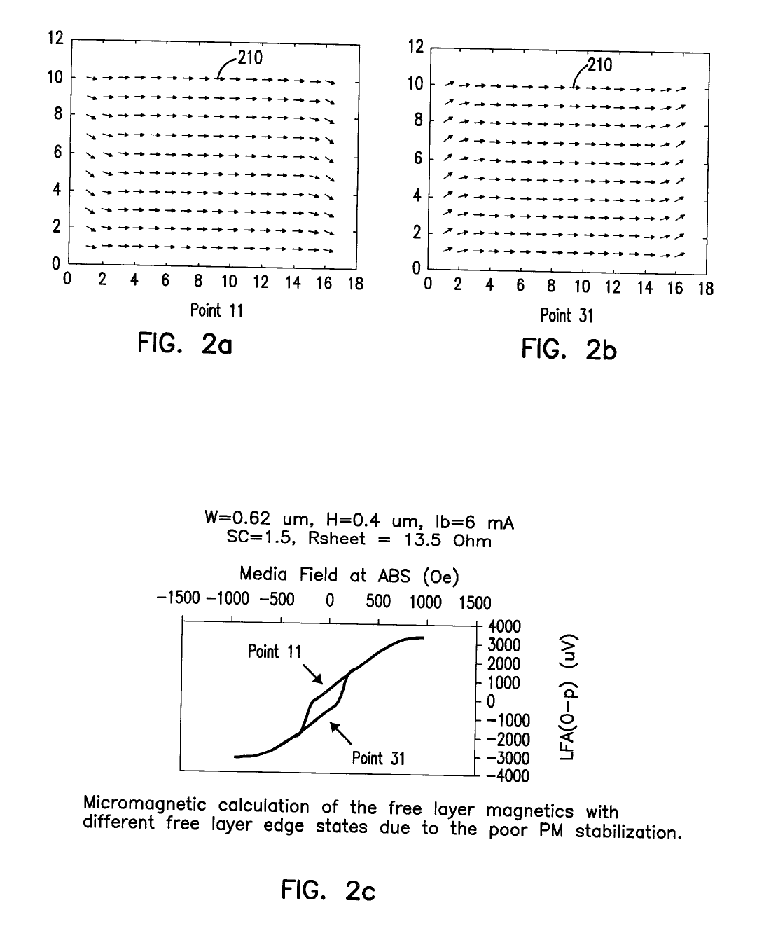

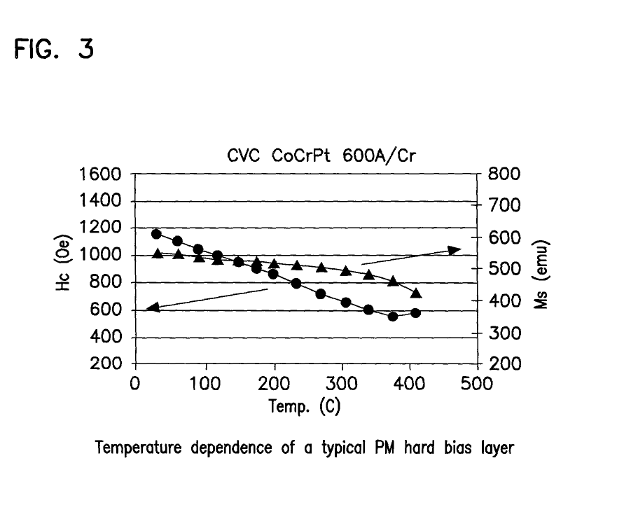

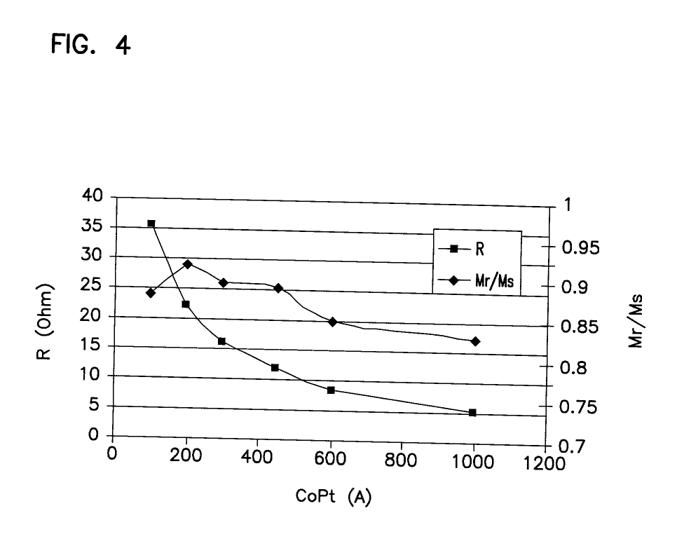

The GMR sensing layer 510 may have any suitable type of GMR structure. In its simplest form the GMR sensing layer 510 may be of the form similar to that illustrated in FIG. 1 and include a ferromagnetic free layer 110 separated from a ferromagnetic pinned layer 120 by a spacer 115. The magnetization of the pinned layer is fixed by a pinning layer 125. The free layer 110 and pinned layer 120 may be made of any suitable ferromagnetic material configured as single layers or multi-layered structures. The suitable materials include Co, NiFe, CoFe, CoZrNb (CZN), NiFeCr, AlSiFe and NiFeRe. The spacer 115 may be made of any suitable conductor, including copper, CuAu and CuAg. The pinning layer may be made of any suitable antiferromagnetic material, include manganese alloys NiMn, FeMn, IrMn, PtPdMn, RuMn, RhMn and CrMnPt. The thicknesses of the various layers may be determined by application requirements. For example, the free layer may be about 2-5 nm thick; the spacer may be about 2-3 nm thick; and the pinned layer may be about 2 to 3 nm thick. Numerous combinations of materials and configurations for GMR sensing layers are well known in the art, including the commonly assigned U.S. Pat. No. 6,134,090, filed on Sep. 15, 1998 and issued on Oct. 17, 2000 to Mao et al and U.S. Pat. No. 5,764, 056, filed on May 16, 1996 and issued on Jun. 9, 1998 to Mao et al., both of which references are incorporated herein by reference.

The separating layer 520 is a non-magnetic layer of high resistivity material, which is positioned between the SAL 530 and the GMR sensing layer to prevent magnetic exchange coupling between these two layers. The resistivity of the separating layer 520 is preferably substantially higher than that of the sensing layer 510 so that it does not shunt current away from the sensing layer 510. For example, the separating layer that for a prior art hard bias layer may be a layer of tantalum Ta having a resistivity of at least 200 μΩ-cm and a thickness of between 5 and 20 nm.

The SAL 530, used to optimize linearity of the magnetoresistive response of the sensor 500, may be made of any suitable material, including a layer of ferromagnetic material such as nickel-iron-rhodium NiFeRh, nickel-iron-rhenium NiFeRe, nickel-iron-chromium NiFeCr, Nickel-Iron-Niobium NiFeNb, Cobalt-Niobium CoNb , Cobalt-Niobium-Zirconium CoNbZr, Cobalt-Hafnium-Tantalum CoHfTa, etc. The resistivity of SAL 530 is preferably at least 100 μΩ-cm to reduce the shunting of current away from the sensing layer 510. SAL 530 may have a thickness of between 10 and 40 nm.

The stack 505 is in continuous contact at two boundaries 532a and 532b with the permanent magnetic hard bias layers 535a and 535b, respectively. The boundaries 532a and 532b may be of a variety of shapes, including stepped as illustrated in FIG. 5, slanted so that the GMR sensing layer 510 is narrower than the SAL 530, and numerous other shapes known in the art.

Each of the hard bias layers 535a and 535b includes at least two layers: a seed layer 550a or 550b, and a permanent magnetic (“PM”) layer 540a or 540b. The hard bias layers 535a and 535b are constructed to provide a sufficient magnetic rigidity of the layers 535a and 535b. That is, the magnetic field from the media (hard disk) must not cause irreversible domain re-orientation. Thus, for the operating conditions where the media generates about 200 to 250 Oe magnetic field near the ABS, the coercivity of the hard bias layers 535a and 535b must be at least about ten times that field strength, or 2,000-2,500 Oe, because non-linearity empirically occurs at about 10% of the coercivity.

The seed layers 550a and 550b may be made of TiW or a variety of other alloys between the elements listed in Table I, which also lists the crystal structures, lattice constants and resistivity of the elements. These elements belong to group IV-B, V-B or VI-B in the periodic table of elements, and have crystal structures of either body-centered-cubic (“bcc”) or hexagonal close-packed (“hcp”). Any alloy between an element with bcc structure and another with hcp structure from Table I may be used for the seed layers 550a and 550b. For example, alloys CrTi, CrW and MoTi may all be used. Any suitable composition of the alloys may be used. For example, according to one preferred embodiment of the present invention, The tungsten (W) content in the TiW seed layer is between about one to about fifteen atomic percent (1-15 at %) The thickness of the seed layer is preferably between about 2 nm and about 5 nm. Alternatively, a bilayer formed between a layer (preferably about 2-5 nm thick) of any of these alloys and a metallic layer (preferably up to about 3 nm thick) of Cr, Ta, CZN and soft magnetic powder such as Sendust™ (an Fe—Al—Si alloy) may be used for the seed layer, with the alloy TiW or similar material in contact with the PM layer 540a or 540b.

TABLE I
Alternative seed layers for high coercivity PM stabilization.

| Metal | W | Mo | Cr | V | Nb | Ta | Ti | Hf | Zr |
|---|---|---|---|---|---|---|---|---|---|
| structure | bcc | bcc | bcc | bcc | bcc | bcc | hcp | hcp | hcp |
| Lattice | 3.16 | 3.15 | 2.88 | 3.03 | 3.30 | 3.30 | 2.95/4.68 | 3.19/5.15 | 3.23/5.15 |
| constant (Å) | | | | | | | | | |
| Resistivity | 5.3 | 5.3 | 12.9 | 19.9 | 14.5 | 13.1 | 43.1 | 30.6 | 42.4 |
| (Ω-cm) | | | | | | | | | |

In the process of manufacturing devices according to the invention, the layer of TiW or similar alloys is the seed layer for the PM layer. That is, the seed layer is deposited on the substrate of intervening layer(s) prior to the deposition of the PM layer. The magnetic properties of the bias layer is improved at least partially due to the more desirable grain size of the PM layer or better lattice matching between the grains of the PM layer, or both, due to the use of the seed layer of TiW or other similar alloys.

It should be noted that alloys such as TiW have been used in GMR sensors as a seed layer for electrical contacts to reduce resistivity. For the purpose of depositing a contact layer, the material for the contact is deposited on the seed layer. In contrast, the seed layer of TiW or similar alloys serves as the foundation for the PM layer deposition according the principles of the invention. In addition, TiW seed layer for electrical contact layers typically has a thickness greater than those used in the illustrative embodiments of the invention. That such alloys would result in high coercivity of the hard bias layer had not been expected prior to this invention.

The PM layers 540a and 540b may be made of any suitable hard bias material. Such materials include compounds CoPt, Co₃Pt, FePt, FePd, FeNd, MnAl, and SmCo₅. In addition, further inclusion of B, Cr, Ta, C, Zr, Rh and Re in the PM layers 540a and 540b may result in an improved coercivity.

The GMR stack 505 and the abutting hard bias layers 535a and 535b are formed on a substrate 560, such as alumina or Si/SiO₂ substrate. It should be understood that the order of the various layers may be changed without deviating from the principles of the invention. Although, for example, the GMR sensing layer 510 is illustrated to be further from the substrate 560 than the SAL (230), the positions of the two layers may be reversed. In either case, the PM layers are deposited on the seed layer.

The hard bias layer, including the seed layer may be formed using a variety of known techniques, including ion-beam deposition (“IBD”) and sputtering.

The hard bias layers made according the principles of this invention have significantly higher coercivity than those of the conventional hard bias layers. For example, the coercivity of the hard bias layers of this invention may be no less than 2,000, 2,300 or 2,500 Oe. The hard bias layers of this invention are also capable of achieving the desired Mrt at smaller thicknesses than the conventional hard bias layers. For example, the requirement an Mrt of the hard bias layer be at least two times the Mst of the free layer may be met by a hard bias layer of this invention, with a layer thickness of no more than 60 nm. In one embodiment, the saturation magnetization of the free layer of about 4 nm thickness is about 1,000 emu/cm³, resulting in an Mst of 0.4×10⁻⁶ emu/cm². In comparison, an Mrt of the hard bias layer made according to the principles of the invention is about 1.5×10⁻⁶ emu/cm², or nearly four times the Mst of the free layer.

The principles of the invention are applicable to a variety of MR sensors that use hard magnets regardless of the location of the hard magnets. U.S. Pat. Nos. 5,381,291, 5,495,378, 5,554,265, 5,712,565, 5,776,537 and 6,144,534 disclose other designs of MR sensors that use hard bias, and all assigned to the assignee of the present invention and are all incorporated herein by reference.

### EXAMPLES

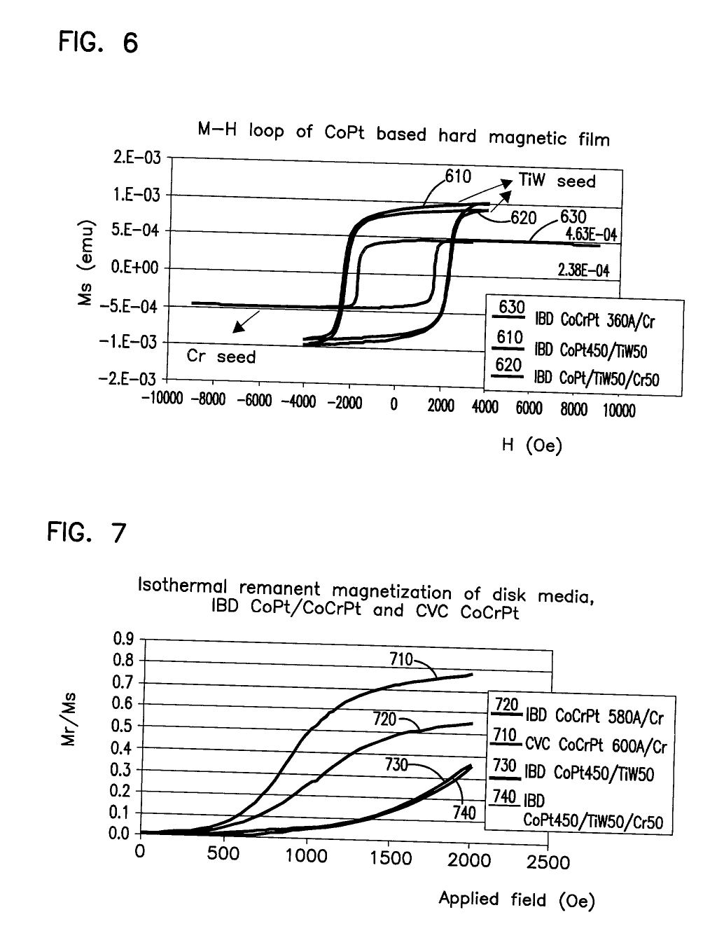

1. FIG. 6 shows a comparison between the major hysteresis loops for (1) 610 a hard bias layer having a 45-nm CoPt PM layer with a 5-nm TiW seed layer according to a preferred embodiment of the present invention; (2) 620 a hard bias layer having a PM layer with a bilayer seed layer of 5 nm Cr and 5 nm TiW in accordance with another preferred embodiment of the present invention, and (3) 630 a prior-art hard bias layer having a 36-nm CoCrPt PM layer with a Cr seed layer. All hard bias layers were formed using ion-beam deposition. Both the TiW-seeded and bilayer-seeded hard bias films show a coercivity of greater than 2,300 Oe and a remnant magnitization of above 8×10⁻³ emu. In comparison, the Cr-seeded film has a coersivity of about 1,800 Oe.

2. FIG. 7 shows a comparison between the remnant magnetization curves of various hard bias films. In this plot a higher vertical position (i.e., higher remnant-magnetization-to-saturation ratio) of a curve indicates an earlier onset (i.e., at lower applied field) of non-linearity in the hard bias layer's response to magnetic signals. Thus, a prior-art hard bias film made of ion-beam-deposited CoCrPt on Cr seed layer (curve 710) has the earliest onset of non-linearity. A prior-art sputtered hard bias film made of CoCrPt on Cr seed layer (curve 720) has an intermediate onset of non-linearity. Both an ion beam deposited bias film made of ion-beam-deposited CoCrPt on a TiW seed layer (curve 730) and an ion beam deposited bias film made of ion-beam-deposited CoCrPt on a TiW/Cr bi-layer seed layer (curve 710) made according to the principles of the present invention have the lowest onset of non-linearity. For example, at about 500 Oe applied field, which is near the upper limit of field typically generated by the recording media, the normalized remnant magnetization values (Mr/Ms) for TiW or TiW/Cr seeded bias films is about 0.01. In comparison, the Cr-seeded films have Mr/Ms of 0.05 or greater.

3. CoPt hard bias layers with different seed layers are compared in Table II in terms of their various magnetic and electrical properties. Layers with TiW and TiW/Cr bi-layers as seed layers show much higher coercivities than the Cr-seeded layers.

TABLE II
Hc and Mr/Ms and Mrt and sheet resistance of
TiW, Cr and Cr/TiW seeded CoPt layer.

| | | | | Mrt | |
|---|---|---|---|---|---|
| Seed Layer | Hc (Oe) | Mr/Ms | Mr (uemu) | (memu/cm2) | R(Ω) |
| Cr (90) | 1482 | 0.8753 | 987.8 | 3.95 | 9.80 |
| Cr (60) | 1620 | 0.8737 | 1012 | 3.69 | 10.03 |
| Cr (45) | 1760 | 0.8711 | 1008 | 3.67 | 9.80 |
| NFC | 754.6 | 0.3398 | 214.7 | 0.80 | 8.97 |
| TiW | 2261 | 0.8872 | 872.8 | 3.31 | 10.04 |
| NFC/Cr | 772.1 | 0.46 | 309.4 | 1.17 | 8.67 |
| TiW/Cr | 1743 | 0.8458 | 763.7 | 3.25 | 8.50 |
| Cr/TiW | 2309 | 0.91 | 823.8 | 3.43 | 8.90 |
| Cr/NFC | 1691 | 0.903 | 852.6 | 3.87 | 9.26 |

4. A spin valve sensor having 40-nm CoCrPt hard-bias layers seeded with TiW according to a preferred embodiment of the present invention is compared with an otherwise identical sensor but with a Cr-seeded film. The result is listed in Table III, in which the parameters are abbreviated as follows:

| | |
|---|---|
| MAR-P: | reader-only static glitch; |
| Stress BLPOP: | stressed baseline popping; |
| RD-W-ASYM: | reader width asymmetry. |

The mean coercivity of the TiW-seeded layer is 2000 Oe, as compared to 1400 Oe for the Cr-seeded film. DC noise, baseline pop noise, and the fluctuations in the various stability parameters (σ associated with, and listed to the right of, each parameter) have also been significantly reduced in the TiW-seeded layer.

TABLE II
Comparison of magnetic stability matrics (mean and Sigma) of 15Gbit/in2
spin valve heads with Cr and TiW seeded CoCrPt 400A layers.

| | | | | | | | | RD | |
|---|---|---|---|---|---|---|---|---|---|
| PM | Hc | MAR- | | Stress | | DC- | | W- | |
| layer | (Oe) | P | σ | BLPOP | σ | noise | σ | ASYM | σ |
| CoCrPt/Cr | 1400 | −3.15 | 1.59 | 2.98 | 3.37 | 195 | 44.5 | 1.57 | 7.54 |
| CoCrPt/TiW | 2000 | −4.07 | 0.426 | 1.34 | 1.1 | 165 | 27 | 0.117 | 5.18 |

5. GMR sensors for operation at 10 Gbit/in² were made and those with TiW-seeded hard bias layers and those with Cr-seeded layers were compared in terms of non-operating stray fields. The sensors with Cr-seeded hard bias layers showed a non-operating threshold of about 25 Oe (less that 20% amplitude change), while the sensors with TiW-seeded hard bias layers had a non-operating threshold of about 75-100 Oe (about 30% amplitude change). The sensors with TiW-seeded hard bias layers also showed improved thermal stability. For example, at 25° C., the variation (measured in 3σ, where σ is the standard deviation) for the stressed base-line pop noise for a spin-valve sensor with TiW-seeded hard bias layer is about 0.34, as compared to 0.47 for a sensor with Cr-seeded hard bias layer. At 70° C., the 3σ-values for the stressed base-line pop noise is about 0.64 for the sensor with TiW-seeded hard bias layer, but 0.99 for the sensor with Cr-seeded hard bias layer.

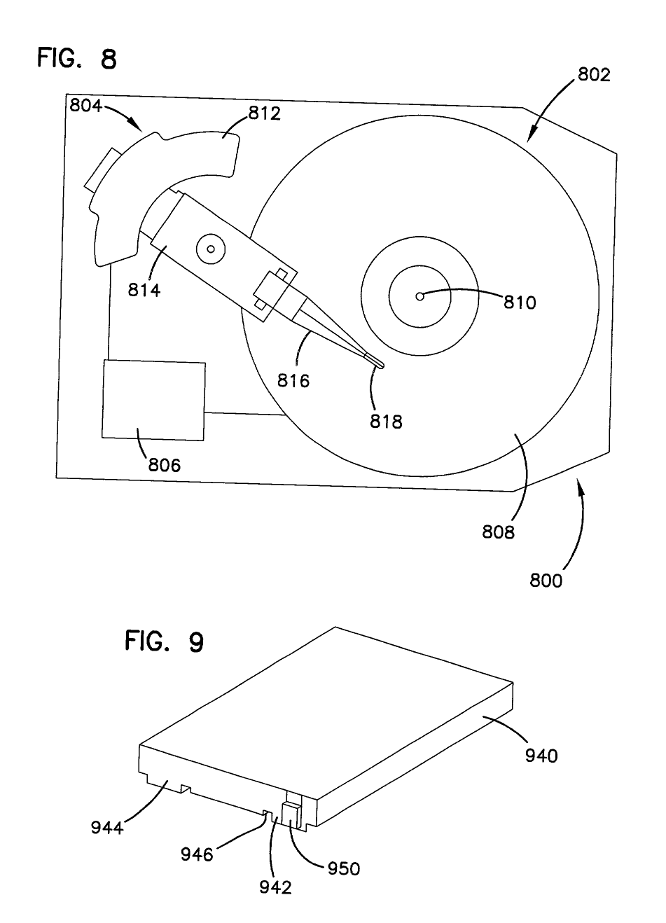

The GMR sensor based on the principle of the invention may be used in a disk drive system based on principles of the invention. FIG. 8 depicts an embodiment of a disc drive system 800 including drive unit 802, actuator assembly 804 and controller 806. Drive unit 802 includes disc 808 and spindle 810 connected to a spindle motor. In the embodiment shown, actuator assembly 804 includes actuator 812, support arm 814, load beam 816 and gimble/head assembly 818. Actuator 812 controls the position of gimble/head assembly 818 over disc 808 by rotating or laterally moving support arm 814. Load beam 816 is located at the end of support arm 814 and gimble/head assembly 818 is located at the end of load beam 816. Controller 806 instructs actuator 812 regarding the position of support arm 814 over disc 808 and drive unit 802 regarding the control of the spindle motor.

Gimble/head assembly 818 includes a slider which, in operation, flies just above the disc surface. FIG. 9 depicts an embodiment of a slider 940. In the embodiment shown, slider 940 includes two rails 942, 944 oriented along the length of air bearing surface 946. Other structure in addition or alternative to rails 942, 944 can be contoured into the air bearing surface to alter the aerodynamic performance of slider 940. GMR spin valve 950 is located at or near the rear edge of slider 940.

The spin valve is deposited in layers onto the slider body. The substrate, on which the spin valve is deposited, is an electrically insulating layer that forms a boundary of the spin valve referred to as a 1st half gap. Additional layers such as an Al₂O₃ base coat and a bottom shield can be placed between the 1st half gap and the slider body. An electrically insulating layer referred to as a second half gap is placed over the spin valve. The entire structure is covered at its top surface with a top shield or shared pole.

The particular embodiments disclosed above are illustrative only, as the invention may be modified and practiced in different but equivalent manners apparent to those skilled in the art having the benefit of the teachings herein. Furthermore, no limitations are intended to the details of construction or design herein shown, other than as described in the claims below. It is therefore evident that the particular embodiments disclosed above may be altered or modified and all such variations are considered within the scope and spirit of the invention. Accordingly, the protection sought herein is as set forth in the claims below.

we claim:

1. A magnetic sensor, comprising:
a. a giant-magnetoresistive sensing layer comprising a ferromagnetic free layer; and
b. a hard bias layer positioned and configured to maintain the free layer in a single-domain state,
wherein the hard bias layer has a coercivity of at least 2,000 Oe.

2. The sensor of claim 1, wherein the hard bias layer has a coercivity of at least 2,300 Oe.

3. The sensor of claim 1, wherein the hard bias layer has a thickness of not more than 60 nm.

4. The sensor of claim 1, wherein the hard bias layer comprises:
a. a seed layer comprising an alloy between two elements chosen from the group consisting essentially of W, Mo, Cr, V, Nb, Ta, Ti, Hf and Zr, wherein the two elements have different crystal structures; and
b. a permanent magnetic layer deposited on the seed layer, wherein the permanent magnetic layer comprises an alloy comprising Co and Pt.

5. The sensor of claim 4, wherein the seed layer comprises TiW with 1 to 15 atomic percent W, and wherein the permanent magnetic layer comprises CoPt.

6. The sensor of claim 4 wherein the seed layer comprises TiW with Ito 15 atomic percent W, and wherein the permanent magnetic layer comprise CoPtx, wherein x is an element chosen from the group consisting essentially of B, Cr, Ta, C, Zr, Rh and Re.

7. The sensor of claim 5, wherein the hard bias layer has a coercivity of at least 2,300 Oe.

8. The sensor of claim 5, wherein the hard bias layer has a coercivity of at least 2,500 Oe.

9. The sensor of claim 6, wherein the hard bias layer has a coercivity of at least 2,300 Oe.

10. The sensor of claim 6, wherein the hard bias layer has a coercivity of at least 2,500 Oe.

11. The sensor of claim 1, wherein the hard bias layer comprises:
a. a seed layer comprising an alloy between two elements chosen from the group consisting essentially of W, Mo, Cr, V, Nb, Ta, Ti, Hf and Zr, wherein the two elements have different crystal structures; and
b. a permanent magnetic layer formed on the seed layer, wherein the permanent magnetic layer comprises a material chosen from the group consisting essentially of Co₃Pt, SmCo₅ and alloys FePt, FePd, FeNdB, and MnAl.

12. The sensor of claim 4, wherein the seed layer further comprises a metallic layer bonded to the alloy layer comprising the alloy, wherein the permanent magnetic layer is in contact with the layer comprising the alloy.

13. The sensor of claim 12, wherein the metallic layer comprises a soft magnetic material.

14. The sensor of claim 13, wherein the soft magnetic material is chosen from the members of the group consisting essentially of Cr, Ta, CrZnNb and an Fe—Al—Si alloy.

15. A magnetic sensor, comprising:
a. a giant-magnetoresistive sensing layer comprising a ferromagnetic free layer having a saturation magnetization; and
b. a hard bias layer positioned to maintain the free layer in a single-domain state, and having a magnetic remnance times thickness at least two times the value of the saturation magnetization times thickness of the free layer.

16. A magnetic disk drive system, comprising:
a. a surface of a magnetic media;
b. a magnetic sensor of claim 1 positioned in proximity to the surface of the magnetic media; and
c. a driving mechanism configured to cause relative motion between the surface and the sensor.

17. A method of making a magnetic sensor, the method comprising:
a. forming a giant-magneto-resistive sensing layer having a top surface, a bottom surface and at least a side surface intersecting the top and bottom surfaces, at an angle substantially different from 180 degrees;
b. depositing seed layer abutting the sensing layer at the side surface, the seed layer comprising an alloy between two elements chosen from the group consisting essentially of W, Mo, Cr, V, Nb, Ta, Ti, Hf and Zr, wherein the two elements have different crystal structures; and
c. depositing, subsequent to step (b), a layer of permanent magnetic material on the seed layer.

18. A magnetic sensor, comprising:
a. a giant-magnetoresistive sensing layer comprising a ferromagnetic free layer; and
b. means for maintaining the free layer in a single-domain state.

19. A method for making a magnetic sensor, the method comprising:
a. providing a giant-magetoresistive sensing layer having a ferromagnetic free layer; and
b. maintaining the free layer in a single-domain state.

20. The method of claim 19, wherein step (b) comprises providing a hard bias layer having a coercivity of at least 2,000 Oe.
